(19) United States
(12) Patent Application Publication
(10) Pub. No.: US 2022/0081141 A1
(43) Pub. Date: Mar. 17, 2022

(54) SYSTEM AND METHOD FOR PACKAGING MEDICAL STOPPERS CONSISTING OF A CAP AND A PLUG

(71) Applicant: A RAYMOND ET CIE, Grenoble (FR)

(72) Inventor: Gaëtan Rey, Voiron (FR)

(21) Appl. No.: 17/398,485

(22) Filed: Aug. 10, 2021

(30) Foreign Application Priority Data
Sep. 11, 2020 (FR) 2009218

(51) Int. Cl. B65B 11/52; B65B 5/06

(52) U.S. Cl. CPC B65B 11/52; B65B 5/068

(57) ABSTRACT

A packaging system for medical stoppers formed by a cap mounted on a plug, the packaging system comprising: a vessel; at least one tray provided with cavities, each of which receives a medical stopper arranged such that the cap, together with an upper face of the tray, defines a closed compartment for individually isolating the plug, the tray being placed in the vessel; and a porous lid sealed on the vessel. This disclosure also relates to a packaging method, comprising the steps of: providing a vessel; arranging a tray in the vessel; arranging at least one stopper in a cavity; sealing a porous lid on the vessel; placing the vessel in at least one sealed bag, and evacuating the bag.

### CROSS-REFERENCE TO RELATED APPLICATION

Pursuant to 35 U.S.C. § 119(a), this application claims the benefit of the filing date of French Patent Application Serial No. FR2009218, filed Sep. 11, 2020, for “System and Method for Packaging Medical Stoppers Consisting of a Cap and a Plug,” the disclosure of which is hereby incorporated herein in its entirety by this reference.

### TECHNICAL FIELD

The present disclosure relates to a packaging system for packaging and dispensing medical stoppers. It also relates to a method for packaging medical stoppers. The disclosure relates more specifically to the packaging, with a view to their distribution, of stoppers composed of a cap and a plug that are intended to close medical vials.

### BACKGROUND

Stoppers of this kind are generally delivered in bulk and poured into a vibrating bowl feeder, or simply placed in a tray, in order to then be placed, by hand or automatically by a machine, one by one on a vial in order to close it.

These delivery solutions are not adequate if the caps are intended to close vials intended for medical use. In this case, the stoppers and the vials must be free from any contamination, in particular, particulate contamination. However, if no particular precaution is taken, the contact and friction between the stoppers themselves or between the stoppers and the surfaces of the tray or vibrating bowl feeder are liable to generate particles that may then be found in the vials. This can have very serious consequences if the vial is used to contain a medical solution intended to be withdrawn by a syringe, since the particles may then be found in the syringe and then injected into the body of a patient.

It is, therefore, important to have a solution for packaging and delivering vial stoppers and, more generally, medical items, that makes it possible to limit the generation of particles.

Documents EP2753550 and U.S. Ser. No. 10/064,787 disclose trays and packaging systems that make it possible to individually store different types of medical items (syringes, vials). These medical items cannot contact each other and, thus, the generation of particles is reduced. EP2753550 seeks, more specifically, to reduce the contact surface area between the medical items and the surface of a tray in order to reduce the zones of friction.

### BRIEF SUMMARY

The object of this disclosure is to provide a packaging system for medical stoppers formed of a cap surmounting a plug, the packaging system comprising:
a vessel having an opening, a bottom, and a peripheral wall;
at least one tray, each having a plurality of receiving spaces and each accommodating a medical stopper arranged such that the cap defines a closed compartment with an upper face of the tray in order to individually isolate the plug, the tray being placed in the vessel; and
a porous lid sealed on the upper edge of the peripheral wall of the vessel in order to close it.

According to other advantageous and non-limiting features of this disclosure, taken alone or in any technically feasible combination:
the vessel is placed, under vacuum, in at least one sealed bag.

According to another aspect, this disclosure provides a method for packaging stoppers formed of a cap surmounting a plug, wherein the method comprises the following steps:
providing a vessel having an opening, a bottom, and a peripheral wall;
arranging a tray having a plurality of receiving spaces at the bottom of the vessel;
arranging at least one stopper in a receiving space such that the cap defines, with an upper surface of the tray, a closed compartment in which the plug is isolated;
sealing a porous lid on an upper edge of the peripheral wall of the vessel; and
placing the vessel in at least one sealed bag, and vacuumizing the bag.

According to other advantageous and non-limiting features of the disclosure, taken alone or in any technically feasible combination:
the lid is made integral with the vessel by being welded to the upper edge of the peripheral wall of the vessel;
the packaging method comprises the following steps:
   providing an additional tray in order to form a stack of trays in the vessel, the additional tray resting on the cap of the stoppers arranged in the receiving spaces of the tray that lies beneath; and
   arranging at least one stopper in a receiving space of the additional tray such that the cap defines, with an upper surface of the tray, a closed compartment in which the plug is isolated.

### BRIEF DESCRIPTION OF THE DRAWING

Other features and advantages of this disclosure will become apparent from the following detailed description, which is provided with reference to the accompanying drawings, in which:

FIG. 1 shows a packaging system according to the present disclosure.

### DETAILED DESCRIPTION

### Description of the Medical Stoppers

The medical stoppers 50 are in this case formed of a cap 51 surmounting a plug 52. More specifically, the plug 52 is formed in the cavity delimited by the cap 51. The cap 51 makes it possible to maneuver the medical stopper 50 in order to close the opening of a container by means of the plug 52 without touching the plug. This limits the risk of contaminating the plug 52 when handling the medical stopper 50 and, therefore, the risk of contaminating the container. A detailed description of such medical stoppers is, for example, available in document FR2950865.

The cap 51 is composed of a head 51a, which is advantageously planar, and a side wall 51b that extends axially from the periphery of the head 51a in order to define the cavity in which the plug 52 is placed.

### General Description of the Packaging System

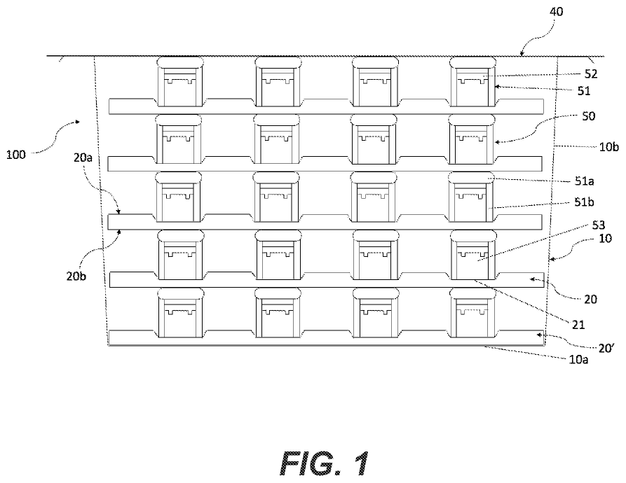

As shown in FIG. 1, a packaging system 100, according to the disclosure, comprises a vessel 10, at least one tray 20 provided with receiving spaces 21, and a porous lid 40 arranged on the opening of the vessel 10 in order to close it. Advantageously, in order to be able to store more medical stoppers 50, the vessel 10 can comprise a plurality of trays 20 that are all identical to one another. These trays 20 thus form a stack, each tray 20 being stacked one on top of the other in parallel with the bottom 10a of the vessel 10. The vessel 10 containing the trays 20, and closed by the porous lid 40, is intended to be placed in at least one airtight bag (and generally two of these bags) in which the air has been evacuated in order to place the entire assembly under vacuum.

Each of the trays 20 accommodates a plurality of medical stoppers 50 stored individually in one of the receiving spaces 21 of the tray 20 without any contact being possible between them. The shape and volume of the receiving spaces 21 will, of course, be adapted such that they can accommodate the medical stopper 50 in question.

### Description of the Vessel

The vessel 10 is a hollow packaging element intended to receive the trays 20 in which the medical stoppers 50 are placed. The vessel 10 comprises an opening, a bottom 10a, and a peripheral wall 10b that define its general shape. The peripheral wall 10b may be provided with a shoulder that allows the vessel 10 to be handled, in particular, by automatic equipment. Advantageously, the vessel 10 has a parallelepipedal shape in order to optimize the space required for storing a given number of medical stoppers 50. The dimensions of the vessel 10 are chosen depending on the number of medical stoppers 50 to be packaged. These dimensions may comply with a norm or a standard so as to facilitate use on an industrial scale. The height of the vessel is chosen and/or adapted according to the number of trays 20 and/or the shape of the medical stoppers 50 to be accommodated. Indeed, the head 51a of the caps 51 of the medical stoppers 50 arranged on the upper tray must be flush with the upper edge of the wall of the vessel such that subsequent vacuumization makes it possible to press the porous lid 40 against the head of the caps. The vessel 10 may be formed from a plastic material, for example, polypropylene, amorphous polyethylene terephthalate, or a styrenic polymer such as polystyrene.

### Description of the Delivery Trays

FIG. 1 shows a packaging system 100 according to the disclosure in which a stack of trays 20 is arranged in the vessel 10. Each tray 20 comprises an upper face 20a and a lower face 20b.

The upper face 20a is provided with a plurality of receiving spaces 21, each intended to receive and secure a single medical stopper 50 in order to prevent any contact between two of the medical stoppers 50. The receiving spaces 21 are typically arranged in rows on the upper face 20a of the tray 20 and, in this case, take the form of a recess 21. The lower face 20b of the tray 20 is advantageously planar in order to facilitate its pressing against the stoppers 50 and, more specifically, against the head 51a of the caps 51, of a tray that lies beneath in the stack of trays. Alternatively, the lower face 20b of the tray 20 could, in a similar manner to the upper face 20a, be provided with a plurality of receiving spaces in order to better limit the movements of the medical stoppers 50.

Optionally, the lower face 20b of the tray intended to be placed against the bottom of the vessel 10, which will be referred to as “lower tray 20′,” may be provided with raised portions in order to allow it to be secured and/or centered in the vessel 10. Indeed, the bottom 10a of the vessel 10 may be provided with centering elements, such as embossments, which can engage with the raised portions on the lower tray 20′. The lower tray 20′ (as well as the entire stack of trays) is thus immobilized in the vessel 10, the friction between the lower tray 20′ and the vessel 10 is limited, and the generation of particles is thus prevented.

The trays 20 may be made of a plastic material, for example, polypropylene or thermoplastic elastomer. Advantageously, the material of the tray 20 has a lower hardness than that of the medical stoppers 50.

### Description of the Lid

The porous lid 40 is intended to be sealed, for example, by means of plastic welding, on the upper edges of the peripheral wall 10b of the vessel 10 once the vessel has been filled with the trays 20 carrying the medical stoppers 50. The porous lid is intended to keep the medical stoppers 50 clean and to prevent particles from entering the vessel 10. The air porosity of the lid 40 makes it possible to extract the air from the vessel during a subsequent vacuuming step. It may, for example, be made of Tyvek®, a material commonly used in the pharmaceutical industry.

### Description of the Packaging Process

In order to minimize contamination by particles and in order to preserve the possible sterility of the medical stoppers 50, the various steps described below are preferably carried out in a controlled environment.

The first tray, the lower tray 20′ of the stack, is arranged on the bottom 10a of the vessel 10. Medical stoppers 50 are then, or were previously, placed in the receiving spaces 21 of the lower tray 20′. The medical stoppers 50 are arranged such that the cap 51 defines a closed compartment 53 with the upper face 20a of the tray in order to individually isolate the plug 52 and protect it from any particulate contamination that could be generated within the packaging system 100. The medical stopper 50 is arranged such that the free end of the side wall 51b is in contact with the bottom of the receiving space 21.

Then, a second tray 20 is arranged in the vessel 10, the lower face 20b of the second tray coming to rest on the head 51a of the caps 51 of the medical stoppers 50 arranged in the receiving spaces 21 of the first tray. Medical stoppers 50 are placed in each receiving space 21 of the second tray 20 before or after this operation. This is repeated as many times as there are trays 20 to be placed in the vessel 10.

The porous lid 40 is then placed on the vessel 10 in order to close it and then made integral with the upper edges of the peripheral wall 10b of the vessel 10.

In a following step, the vessel 10, the opening of which has been closed by the porous lid 40, is placed in at least one airtight bag (and preferably two bags for safety reasons), and the vacuuming is carried out in this bag before it is hermetically sealed. The vacuumization of the entire assembly makes it possible to vertically block the various components of the system 100 by pressing the porous lid 40 against the medical stoppers 50 of the upper plate. The vacuumization also makes it possible to press the medical stoppers 50 against the upper face 20a of the tray on which they are placed in order to form hermetic compartments 53 in which each plug 52 is individually arranged. The vacuumization also makes it possible to horizontally block the various components of the system 100 by deforming the peripheral wall 10b of the vessel 10 in order to press it against the edge of the trays 20. The vacuumization, therefore, makes it possible to limit the friction between the various elements of the system 100 and, thus, the generation of particles by friction by blocking the vertical and horizontal movement of the elements.

### Opening the Packaging System

To open the packaging system and access the medical stoppers 50 packaged therein, the vessel 10 containing the stack of trays 20 is, first of all, taken out of the bag. The porous lid 40 is then removed to expose the medical stoppers 50. The medical stoppers 50 can then be picked up individually or row by row, manually and/or automatically by a machine. Once the tray at the top of the stack has been emptied of its medical stoppers 50, the tray is also removed to expose the medical stoppers of the tray that lies beneath. These operations are repeated until all the medical stoppers 50 stored in the vessel 10 have been removed.

Of course, the invention is not limited to the embodiments described and it is possible to add variants without departing from the scope of the invention as defined by the claims.

Although a stack of trays is shown here in the vessel, it is, of course, possible to have only one tray arranged in the vessel.

What is claimed is:

1. A packaging system for medical stoppers formed by a cap mounted on a plug, the packaging system comprising:
a vessel having an opening, a bottom and a peripheral wall;
at least one tray, each of which has a plurality of cavities that each receive a medical stopper arranged such that the cap, together with an upper face of the tray, defines a closed compartment for individually isolating the plug, the tray being placed in the vessel; and
a porous lid sealed on an upper edge of the peripheral wall of the vessel so as to close the vessel.

2. The system of claim 1, wherein the vessel is placed, under vacuum, in at least one sealed bag.

3. A method of packaging stoppers formed by a cap mounted on a plug, the method comprising the following steps:
providing a vessel having an opening, a bottom and a peripheral wall;
arranging a tray having a plurality of cavities at the bottom of the vessel;
arranging at least one medical stopper in a cavity such that the cap, together with an upper surface of the tray, defines a closed compartment in which the plug is isolated;
sealing a porous lid on an upper edge of the peripheral wall of the vessel; and
placing the vessel in at least one sealed bag, and evacuating the at least one sealed bag.

4. The method of claim 3, wherein the porous lid is rigidly connected to the vessel by being welded onto the upper edge of the peripheral wall of the vessel.

5. The method of claim 4, further comprising the following steps:
arranging an additional tray to form a stack of trays in the vessel, the additional tray abutting the cap of the stoppers arranged in the cavities of the plurality of cavities of an underlying tray; and
arranging at least one stopper in a cavity of the additional tray such that the cap, together with an upper surface of the tray, defines a closed compartment in which the plug is isolated.

6. The method of claim 3, further comprising the following steps:
arranging an additional tray to form a stack of trays in the vessel, the additional tray abutting the cap of the stoppers arranged in the cavities of the plurality of cavities of an underlying tray; and
arranging at least one stopper in a cavity of the additional tray such that the cap, together with an upper surface of the tray, defines a closed compartment in which the plug is isolated.
